(19) United States
(12) Patent Application Publication
(10) Pub. No.: US 2013/0106997 A1
(43) Pub. Date: May 2, 2013

(54) APPARATUS AND METHOD FOR GENERATING THREE-DIMENSION DATA IN PORTABLE TERMINAL

(71) Applicants: Jae-Hyun KIM, Gyeonggi-do (KR); Kyung-Seok OH, Seoul (KR); Kyoung-Ho BANG, Seoul (KR); In-Yong CHOI, Gyeonggi-do (KR)

(72) Inventors: Jae-Hyun KIM, Gyeonggi-do (KR); Kyung-Seok OH, Seoul (KR); Kyoung-Ho BANG, Seoul (KR); In-Yong CHOI, Gyeonggi-do (KR)

(73) Assignee: SAMSUNG ELECTRONICS CO., LTD., Gyeonggi-do (KR)

(21) Appl. No.: 13/611,690

(22) Filed: Sep. 12, 2012

(30) Foreign Application Priority Data
Oct. 26, 2011 (KR) 10-2011-0109821

(51) Int. Cl. H04N 13/00

(52) U.S. Cl. 348/43; 348/E13.003

(57) ABSTRACT

A portable terminal for generating and reproducing stereoscopic data is provided. More particularly, an apparatus and method for providing stereoscopic audio by applying a sense of distance to audio data by the use of subject information of image data when generating the stereoscopic data are provided. An apparatus for generating stereoscopic data in the portable terminal includes an image processor for applying a stereoscopic effect to image data by acquiring the image data for generating the stereoscopic data via a plurality of cameras, and for recognizing subject motion information of the image data. An audio processor applies a stereoscopic effect to audio data in accordance with the subject motion information ascertained from video data after acquiring audio data for generating the stereoscopic data.

### CLAIM OF PRIORITY

This application claims the benefit of priority under 35 U.S.C. § 119(a) from a Korean patent application filed in the Korean Intellectual Property Office on Oct. 26, 2011 and assigned Serial No. 10-2011-0109821, the entire disclosure of which is hereby incorporated by reference in its entirety.

### BACKGROUND OF THE INVENTION

1. Field of the Invention

The present invention relates to an apparatus and method of a portable terminal for generating and reproducing stereoscopic data.

2. Description of the Related Art

Research on 3-Dimensional (3D) data implementation mechanisms is actively ongoing in the image technologies in order to express image information having a more realistic look. Accordingly, 3D brings the user closer to a realistic look by devices. There is a known method for providing a 3D stereoscopic sense by using a human visual feature. In this method, a left-viewpoint image and a right-viewpoint image are scanned onto respective positions of the conventional display device and thereafter the two images are separately perceived by the left and right eyes of a viewer. This method is widely recognized as a possible method in several aspects, particularly as a human's depth perception is based on the right eye and left eye having slightly different views of an image.

For example, such devices that are benefitting from such 3D development include a portable terminal equipped with a barrier Liquid Crystal Display (LCD) (i.e., a stereoscopic mobile phone, a stereoscopic camera, a stereoscopic camcorder. etc.,), and a 3D TeleVision (TV), all of which set can provide a more realistic image to a user by reproducing stereoscopic contents.

In general, a stereoscopic image is different from the conventional image in that an image is captured by using two camera modules separated from each other by a specific distance and thereafter two images are combined and used. In other words, the stereoscopic image is created by composite viewpoints as would be viewed from right and left eyes of a user. The two images can be arranged in a lengthwise or widthwise direction.

At present, methods of outputting the stereoscopic image are classified into two possible types, i.e., a spectacle type (i.e. 3D glasses) and a non-spectacle type. First, in case of the spectacle type, a viewing angle is limited and a stereoscopic effect is significantly great. Thus, the spectacle type is used for a device having a great output, such as a TV set. Second, in case of the non-spectacle type, a barrier LCD is used, and thus it is suitable for a portable terminal since spectacles are not used. However, the non-spectacle type has a great limitation in a viewing angle.

In general, the portable terminal provides the stereoscopic effect for image data. In other words, when the stereoscopic data is reproduced in the portable terminal, the stereoscopic effect is applied only to the image data and is not applied to audio data, which causes a problem in that a two-dimensional sound is provided to three dimensional images. This problem exists because a channel of audio data acquired by the portable terminal is not sufficient to provide a three-dimensional sound.

Accordingly, in order to solve at least some of the aforementioned problems, there is a need for an apparatus and method for applying a stereoscopic effect (indication of depth perception) to audio data in a portable terminal.

### SUMMARY OF THE INVENTION

The present invention in an aspect thereof provides an apparatus and method for providing a stereoscopic sound in a portable terminal.

Another exemplary aspect of the present invention is to provide an apparatus and method for generating stereoscopic data that provides a stereoscopic effect to both audio data and image data in a portable terminal

Another exemplary aspect of the present invention is to provide an apparatus and method for applying a sense of distance of sounds made by different subjects (entities) to audio data in accordance with information of a subject included in image data in a portable terminal.

Another exemplary aspect of the present invention is to provide an apparatus and method that provides a stereoscopic effect (indication of depth perception) to audio data by recognizing subject information when stereoscopic data is reproduced in a portable terminal.

In accordance with another exemplary aspect of the present invention, an apparatus for generating stereoscopic data in a portable terminal is provided. The apparatus includes an image processor for applying a stereoscopic effect to image data by acquiring the image data for generating the stereoscopic data, and for recognizing subject motion information of the image data, and an audio processor for applying a stereoscopic effect (indication of depth perception) to audio data in accordance with the subject motion information after acquiring audio data for generating the stereoscopic data.

In accordance with yet another exemplary aspect of the present invention, a method of generating stereoscopic data in a portable terminal is provided. The method includes acquiring image data and audio data for generating the stereoscopic data, recognizing subject motion information from the image data, applying the stereoscopic effect to the image data, and applying the stereoscopic effect to the audio data in accordance with the subject motion information.

In accordance with still another exemplary aspect of the present invention, an electronic device is provided. The electronic device includes one or more processors or microprocessors comprising hardware, a non-transitory memory, and one or more modules stored in the memory and configured to be executed by the one or more processors or microprocessors, wherein the module acquires image data and audio data for generating the stereoscopic data, recognizes subject motion information from the image data, applies the stereoscopic effect to the image data, and applies the stereoscopic effect to the audio data in accordance with the subject motion information.

Moreover, in an aspect of an apparatus for generating stereoscopic data in a portable terminal, the apparatus includes: an image processor that applies a stereoscopic effect to image data by acquiring the image data for generating the stereoscopic data, identifies a subject from the image data and recognizes subject motion information of the image data; and an audio processor that applies to acquired audio data a stereoscopic effect to the audio data that corresponds with the subject identified in the image data in accordance with the recognized subject motion information of the image data.

The image processor preferably includes a subject checker that separates the acquired image data into the subject corresponding to a focal point and a background; and a location information analyzer that confirms a location information of the subject separated by the subject checker. In addition, the image processor preferably includes a distance information analyzer that confirms distance information of the subject separated by the subject checker by recognizing a subject location of previous image data and compares with a subject location of the acquired image data (i.e. current image data), and thereafter confirms distance information based on a subject motion of the subject.

According to an exemplary aspect of the present invention, the audio processor preferably includes a signal extractor that separates from the acquired audio data a first audio data generated from the subject and a second audio data generated from the background; and an effect applying unit that applies the stereoscopic effect to the first audio data and the second audio data by using the subject motion information of image data recognized by the image processor. The effect applying unit configures the first audio data or the second audio data in accordance with the subject motion information.

In addition, the apparatus according to the present invention may include a microphone array which record sounds from the subject and the background at different angles utilizing a beamforming technique.

### BRIEF DESCRIPTION OF THE DRAWINGS

The above and other exemplary aspects, features and advantages of certain exemplary embodiments of the present invention will become more apparent to a person of ordinary skill in the art from the following detailed description taken in conjunction with the accompanying drawings, in which:

FIG. 1A illustrates an exemplary portable terminal that applies a stereoscopic effect to audio data according to an exemplary embodiment of the present invention;

FIG. 1B is a block diagram illustrating a structure of an image processor for providing a stereoscopic effect according to an exemplary embodiment of the present invention;

FIG. 1C is another block diagram illustrating a structure of an audio processor for providing a stereoscopic effect according to an exemplary embodiment of the present invention;

FIG. 2 is a flowchart illustrating exemplary operation a process of generating stereoscopic data in a portable terminal according to an exemplary embodiment of the present invention;

FIG. 3 is a flowchart illustrating exemplary operation of a process of applying a stereoscopic effect to audio data in a portable terminal according to an exemplary embodiment of the present invention;

FIG. 4A illustrates a screen for conventionally reproducing stereoscopic data of a typical portable terminal;

FIG. 4B illustrates a screen for reproducing stereoscopic data of a portable terminal according to an exemplary embodiment of the present invention; and

FIG. 5 is a flowchart illustrating exemplary operation a process of recognizing a time at which a stereoscopic effect is to be applied to audio data in a portable terminal according to another exemplary embodiment of the present invention.

### DETAILED DESCRIPTION

Exemplary embodiments of the present invention are described herein below with reference to the accompanying drawings. In the following description, well-known functions or constructions may not be described in detail when they would obscure appreciation of the invention by a person of ordinary skill in the art with unnecessary detail.

The description herein below relates to an apparatus and method for applying a sense of distance to audio data by using subject information of image data in order to apply a stereoscopic effect to the audio data, and the image data captured by a plurality of camera modules in a portable terminal according to the present invention. Herein, the portable terminal preferably includes a display unit capable of providing the stereoscopic effect, and implies a display device for providing a stereoscopic sense to a user by reproducing stereoscopic contents such as a 3 Dimensional (3D) mobile communication terminal, a 3D camera, a 3D camcorder, a 3D TeleVision (TV) set, etc. In addition thereto, the portable terminal corrects a sense of distance to a background audio signal and a main audio signal after confirming a subject motion of the image data.

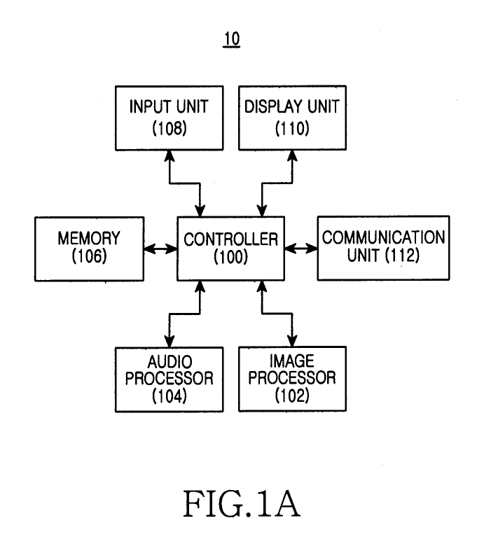

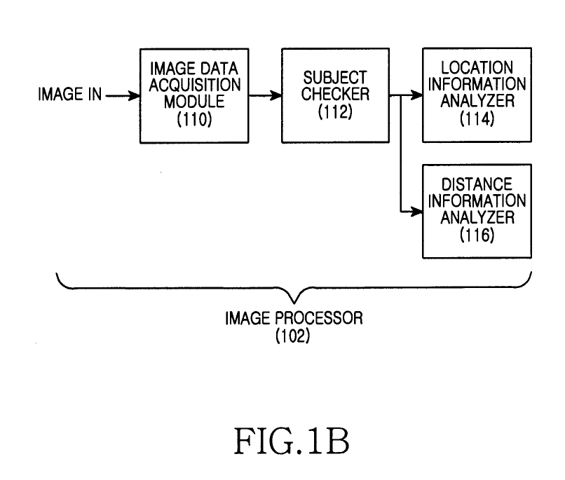

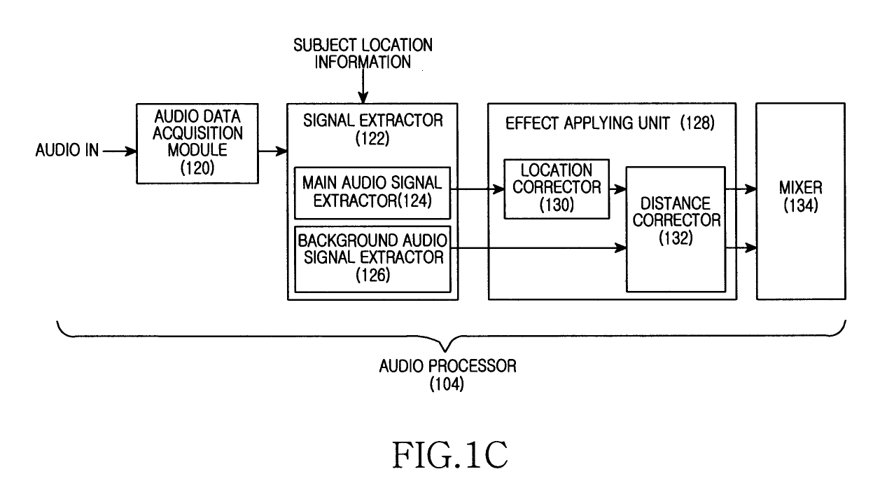

FIG. 1 is a block diagram illustrating a structure of a portable terminal that generates stereoscopic data for both image and sound according to an exemplary embodiment of the present invention.

FIG. 1A illustrates a portable terminal that applies a stereoscopic effect to audio data according to an exemplary embodiment of the present invention.

Referring now to FIG. 1A, the portable terminal 10 may preferably include a controller 100, an image processor 102, an audio processor 104, a memory 106, an input unit 108, a display unit 110, and a communication unit 112.

First, the controller 100 of the portable terminal provides an overall control of the portable terminal. For example, the controller, which comprises hardware such as a processor or microprocessor 100 performs processing and controlling of voice telephony and data communication. In addition to the typical function, according to the present invention, the controller 100 provides control to acquire a plurality of pieces of image data and audio data, and then to generate stereoscopic data by applying a stereoscopic effect to the acquired data (i.e., to both the image data and the audio data), and to reproduce the stereoscopic data. In this case, the controller 100 provides control to apply the stereoscopic effect to the image data by combining the image data corresponding to a plurality of viewpoints (views from different angles), and applies the stereoscopic effect (indication of depth perception) to the audio data by using subject motion information (i.e., location information and distance information) of the image data. The stereoscopic effect to the audio data hereunder may indicate depth perception which may be a sense of distance of sound made by different subject (entities))

The image processor 102 acquires a plurality of pieces (portions) of image data for providing the stereoscopic effect under the control of the controller 100. In this case, the image processor 102 can acquire the image data by simultaneously capturing the same subject by using a camera module equipped at different viewpoints (or angles), and can generate the image data to provide the stereoscopic effect by combining the acquired image data.

In addition, the image processor 102 separates a subject (for example, people) of the acquired image data under the control of the controller 100, recognizes motion information (i.e., location and distance information) of the subject, and provides the information to the audio processor 104.

The audio processor 104 acquires audio data for providing the stereoscopic effect under the control of the controller 100. In this case, the audio processor 104 acquires audio data generated in the subject and background of the image data by using a plurality of microphones and subsequently applies the stereoscopic effect to the audio data in accordance with the motion information of the subject. In addition, the audio processor 104 may preferably include a speaker (or speakers) for reproducing and outputting the audio data to which the stereoscopic effect is applied, and the audio processor 104 can apply the stereoscopic effect to the audio data by using the distance information of the subject.

Operations of the controller 100, the image processor 102, and the audio processor 104 can be executed by a specific software module (i.e., a command set) stored in the memory 104 when loaded into the controller to configure the controller to perform functions.

In other words, operations of the controller 100, the image processor 102, and the audio processor 104 can be configured in a software or hardware manner, but the claimed invention is not pure software, as the software would be loaded into hardware such as a microprocessor or processor for operation. Further, the image processor 102 and the audio processor 104 can be defined by respective controllers. Furthermore, the controller 100 can be defined as one processor, and the image processor 102 and the audio processor 104 can be defined as another processor, or even two more processors in addition to the processor constituting the controller.

With continued reference to FIG. 1A, the memory 106 preferably includes a Read Only Memory (ROM), a Random Access Memory (RAM), and a flash ROM. The ROM stores a microcode of a program 100 that when loaded into the processor to configure the processor provides for processing and controlling the controller 100, the image processor 102, and the audio processor 104 and a variety of reference data.

The RAM preferably comprises a working memory of the controller 100 and stores temporary data that is generated while programs are performed. The flash ROM stores rewritable data, such as phonebook entries, outgoing messages, and incoming messages. According to the exemplary embodiment of the present invention, the flash ROM stores stereoscopic data generated by using audio data and image data to which the stereoscopic effect is applied.

According an exemplary to the present invention, the memory 106, which comprises a non-transitory memory stores a software module in the form of machine-readable code that when executed by a processor performs operations of the controller 110, the image processor 102, and the audio processor 104. The software modules may be executed by the controller 100.

The input unit 108 includes a plurality of function keys (which may be virtual keys if the input is a touch input) such as numeral key buttons of ‘0’ to ‘9’, a menu button, a cancel (delete) button, an OK button, a talk button, an end button, an Internet access button, a navigation key (or direction key) button, and a character input key. Key input data, which is input when the user presses these keys (or touches their image in the case of a virtual keypad), is provided to the controller 100. Further, the input unit 108 generates data for requesting stereoscopic data generation to provide the stereoscopic effect.

The display unit 110 displays information such as state (status) information, which is generated while the portable terminal operates, limited numeric characters, large volumes of moving and still pictures, etc. The display unit 110 may comprise, for some non-limiting examples, a color Liquid Crystal Display (LCD), an Active Matrix Organic Light Emitting Diode (AMOLED), etc. The display unit 110 may include a touch input device as an input device when using a touch input type portable terminal Further, the display unit 110 may include an LCD (e.g., a barrier LCD) capable of providing the visual stereoscopic effect according to the present invention, and can output image data to which the stereoscopic effect is applied.

In fact, it is within the spirit and scope of the presently claimed invention that the input unit 108 and display unit 110 could all be served by a single touch screen. In other words, a touch sensitive display, called as a touch screen, may be used as the display unit 110. In this situation, touch input may be performed via the touch sensitive display.

With continued reference to FIG. 1, the communication unit 114 transmits and receives a Radio Frequency (RF) signal of data that is input and output through an antenna (not illustrated). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data. However, spread spectrum communication is not a requirement of the present invention, and there are a multitude of protocols that the communication unit may perform.

Although the functions of the image processor 102 and the audio processor 104 can be performed by the controller 100 of the portable terminal, these elements are separately constructed in the present invention for exemplary purposes only. Thus, those ordinary skilled in the art can understand that various modifications can be made within the scope of the present invention. For example, these elements may be constructed such that their functions are processed by the controller 100.

FIG. 1B is a block diagram illustrating a structure of an image processor for providing a stereoscopic effect according to an exemplary embodiment of the present invention.

Referring now to FIG. 1B, an image processor 102 may preferably include an image data acquisition module 110, a subject checker 112, a location information analyzer 114, and a distance information analyzer 116.

The image data acquisition module 110 preferably include a camera module that may be comprised of, for example, a charged coupled device (CCD), and acquires a plurality of pieces of image data by using a digital image signal which is input to the camera module. In this case, the image data acquisition module 110 may include a plurality of camera modules, and acquires a plurality of pieces of image data having different viewpoints since the pieces of image data are acquired by capturing the same subject in different angles.

The subject checker 112 separates a subject and a background from image data that is acquired by the image data acquisition module 110. Herein, the subject may be a focal point area of the image data to be acquired by a user.

The location information analyzer 114 confirms a location of the subject separated by the subject checker 112. The distance information analyzer 116 confirms distance information of the subject separated by the subject checker 112. In this case, the distance information analyzer 116 recognizes a subject location of previous image data and a subject location of the currently acquired image data, and thereafter confirms distance information based on a subject motion.

Thereafter, the image processor 102 provides the audio processor 104 with the motion information of the subject confirmed by the location information analyzer 114 and the distance information analyzer 116, and generates stereoscopic data by combining a plurality of pieces of image data having different viewpoints and acquired by the image data acquisition module 110 into one piece of image data. The motion information provided by the image processor 102 to the audio processor include distance information of distance of subjects (entities) in the image data so that the audio processor may use the distance information to make indication of depth perception which is a sense of distance of sounds made by different subjects (entities).

As described above, since an operation of the image processor 102 can be executed by a specific software module (i.e., a command set) stored in the memory 106 that is loaded into hardware for operation, operations of components constituting the image processor 102 can be similarly performed.

FIG. 1C is a block diagram illustrating a structure of an audio processor for providing a stereoscopic effect according to an exemplary embodiment of the present invention.

Referring now to FIG. 1C, the audio processor 104 may preferably include an audio data acquisition module 120, a signal extractor 122, an effect applying unit 128, and a mixer 134. The signal extractor 122 includes a main signal extractor 124 and a background signal extractor 126. In addition, the effect applying unit 128 can further include a location corrector 130 and a distance corrector 132.

The audio data acquisition module 120 includes at least one or more microphones, and acquires a plurality of pieces of audio data by using a digital audio signal which is input to the microphones. In this case, the audio data includes audio data generated from a subject of image data and audio data generated from a background of the image data. The subjects in the foreground may make sounds that are softer than sounds coming from the backgrounder, for example, when a train is passing in the background while a person in the foreground is speaking. Also, people moving in the foreground may make sounds softer than people moving in the background.

The signal extractor 122 separates first audio data and second audio data from the audio data on the basis of subject location information (i.e., subject motion). This is to extract the first audio data (i.e., a main audio signal) corresponding to the subject and the second audio data (i.e., a background audio signal) corresponding to the background from the acquired audio data.

The main signal extractor 124 extracts a main audio signal from the audio data which is input to the audio data acquisition module 120 by using the subject motion information. In this case, the main audio signal extractor 124 can separate the main audio data by aiming a subject direction on the basis of a microphone array and beamforming technique, and can separate the main audio signal (i.e., a signal of a pure stereo component in which a mono component is removed) by dividing a common component (i.e. a mono component) of one or more simply input audio channels.

The background audio signal extractor 126 extracts a background signal from the audio data which is input to the audio data acquisition module 120 by using the subject motion information. In this case, the background audio signal extractor can extract surrounding background audio signals (i.e. at least a second audio signal) by aiming a background direction on the basis of a microphone array and a beamforming technique, and can extract a background audio signal by using a method of subtracting a main (i.e. first audio signal) audio signal from one or more input audio channels. A conventional known beamforming technique is being used for reception.

The effect applying unit 128 applies the stereoscopic effect to the main audio signal or the background audio signal in accordance with the subject motion.

The location corrector 130 of the effect applying unit 128 localizes the main audio signal and the background audio signal on the basis of a location of the subject to provide the user with an improved sense of reality so that sound can be perceived with relative depth. In this case, the location corrector 130 can synchronize the main signal and the background signal in accordance with the location information on the basis of a Head Related Transfer Function (HRTF) or can synchronize the main audio signal and the background audio signal by using left/right panning signal processing with respect to a front side.

The distance corrector 132 of the effect applying unit 128 applies a distance effect to the main audio signal synchronized with the location of the subject. In this case, the distance corrector 132 applies the distance effect to the main audio signal by using the distance information of the subject confirmed by the distance information analyzer 116 of the image processor 102. That is, the distance corrector 132 can apply the distance effect in such a manner that, if the subject is apart far from a reference point, strength of the main audio signal is regulated to be low, an amount of a low-frequency signal is relatively subtracted, and a reverberation is added. On the contrary, if the subject approaches near the reference point, the strength of the main audio signal is regulated to be great, and the amount of the low-frequency signal is increased. The signal extractor 122 extracts a main audio signal and a background signal from an audio signal by respective extractors 124 and 122. Further, the distance corrector 132 maintains strength of overall audio data (i.e., main audio signal+background audio signal) to be constant by regulating a magnitude (strength) of the background audio signal according to a change of main audio signal strength. The mixer 134 generates audio signal acquired by adding the background audio signal and the main audio signal to which an effect based on the subject motion (i.e., location and distance) is applied. Here, the strength may a volume of sound. Therefore, the distance corrector may alter the volume of sound of the background audio signal in accordance with the change of the volume of sound of the main audio signal.

As described above, since an operation of the audio processor 104 can be executed by a specific software module (i.e., a command set) stored in the memory 106 that is loaded into hardware such as a processor or microprocessor, operations of components constituting the audio processor 104 can also be performed by the processor loaded with command set of the software module.

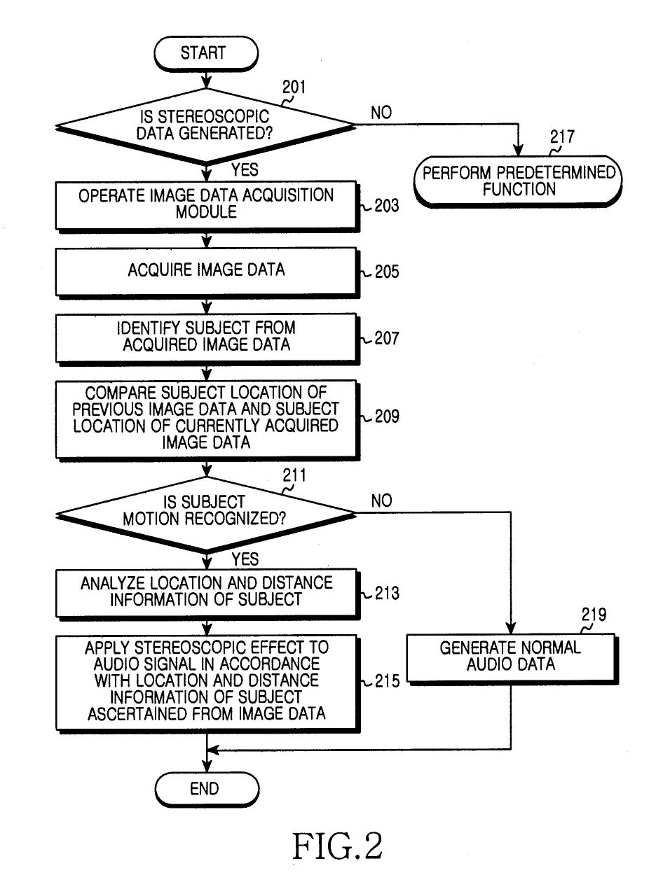

FIG. 2 is a flowchart illustrating a process of generating stereoscopic data in a portable terminal according to an exemplary embodiment of the present invention.

Referring now to FIG. 2, the portable terminal determines whether to generate stereoscopic data in step 201. Herein, the stereoscopic data is data acquired by combining image data for a subject captured by using a plurality of camera modules equipped in different angles into one piece of data, and can provide the stereoscopic effect to the user by using a stereoscopic image viewer (e.g., a barrier LCD). The stereoscopic data can provide not only the stereoscopic effect for the image data but also the stereoscopic effect for the audio data through the use of recording sounds at different angles, such as a by a microphone array and a beamforming technique.

If it is determined in step 201 that the stereoscopic data is not generated, proceeding to step 217, the portable terminal performs a predetermined function (e.g., a standby mode).

Otherwise, if it is determined in step 201 that the stereoscopic data is generated, proceeding to step 203, the portable terminal operates an image data acquisition module. In step 205, the portable terminal acquires image data by using the image data acquisition module. Herein, the image data acquisition module implies a camera module capable of acquiring still image data or motion image data. The portable terminal can include a plurality of camera modules to acquire different pieces of image data having different viewpoints with respect to the same subject.

In step 207, the portable terminal recognizes the subject from the image data acquired by using the image data acquisition module.

In step 209, the portable terminal recognizes a subject location of previous image data and a subject location of currently acquired image data. In step 211, the portable terminal determines whether a motion of the subject is recognized. This is to recognize whether the subject of the acquired image data has changed its location or whether the subjects is moving, and is to determine a location change of the subject of the acquired image data.

If the motion of the subject is not detected in step 211, proceeding to step 219, the portable terminal generates normal audio data. In this case, the portable terminal maintains audio data generated from a background and audio data generated from the subject such that the two pieces of data have constant strength (volume of sound).

Otherwise, if the motion of the subject is detected in step 211, proceeding to step 213, the portable terminal analyzes location and distance information of the subject. In this case, the portable terminal can recognize an extent of change in a subject location of previous image data and a subject location of currently acquired image data, and thus can recognize the location and distance information of the subject.

In step 215, the portable terminal applies the stereoscopic effect to the audio data in accordance with the location and distance information of the subject that has been ascertained from the image data. In other words, the portable terminal can apply a sense of distance to audio data by increasing strength of a main audio signal corresponding to the subject and by decreasing strength of audio data corresponding to the background according to the exemplary embodiment of the present invention. In addition, when the subject moves in a direction of a viewer of image data, the portable terminal can improve a listening effect of the user by gradually increasing the strength of the main audio signal for the subject.

In summary, the portable terminal according to the present invention acquires image data for stereoscopic data and thereafter determines whether to apply the effect ascertained from image data to audio data by using a subject of the acquired image data and applies the effect to a main audio signal and a background audio signal depending on a motion of the subject.

Thereafter, the portable terminal reproduces audio data and image data to which the stereoscopic effect is applied, and then the procedure of FIG. 2 ends.

The method performed according to FIG. 2 may be provided as one or more instructions in one or more software modules stored in the storage unit that are loaded into hardware such as a microprocessor or processor. The software modules may be executed by the controller 100.

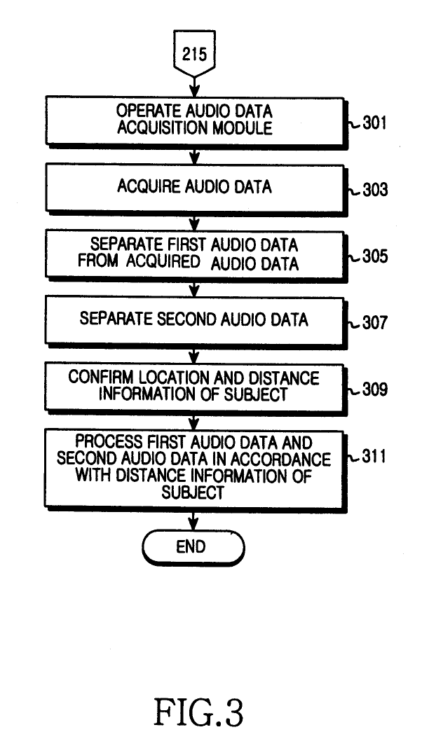

FIG. 3 is a flowchart illustrating a process of applying a stereoscopic effect to audio data in a portable terminal according to an exemplary embodiment of the present invention.

Referring now to FIG. 3, the portable terminal operates an audio data acquisition module in step 301, and then acquires audio data in step 303. Herein, the audio data acquisition module implies a microphone capable of collecting audio data generated around image data when the image data is acquired. For example, the portable terminal can have a plurality of microphones, which may be arranged in an array and/or adjacent to video camera modules and thus can acquire audio data generated from a subject of the image data and audio data generated from a background other than the subject based on the image data.

In step 305, the portable terminal separates first audio data (i.e., a main signal) from the acquired audio data. The first audio data is the audio data generated from the subject of the image data that is used to detect whether a subject is in motion, and the corresponding sound associated with the subject. Herein, the portable terminal separates the first audio data on the basis of subject location information of the image data. In this case, the portable terminal can separate the first audio data by aiming a subject direction on the basis of a microphone array and beamforming technique. In addition, the portable terminal can separate the first audio data consisting of pure stereo components by dividing a common component (i.e., mono component) of one or more audio channels which are simply input.

In step 307, the portable terminal separates second audio data (i.e., a background signal) which is audio data generated around image data (ascertained by image data) from the acquired audio data.

In this case, the portable terminal extracts background audio data other than the first audio data from the acquired audio data. As described above, the portable terminal can extract the second audio data regarding a surrounding background by aiming a background direction on the basis of the microphone array and a beamforming technique. In addition, the portable terminal can extract the second audio data by subtracting the first audio data from the acquired audio data.

In step 309, the portable terminal confirms location and distance information for the subject of the image data. In step 311, the portable terminal applies a stereoscopic effect to the first audio data and the second audio data in accordance with the location and distance information of the subject.

In other words, the portable terminal determines a direction, angle, or the like at which the first audio data and the second audio data are generated in accordance with the distance information of the subject that has been ascertained from the analysis of the image data. The portable terminal can synchronize the first audio data and the second audio data in accordance with the distance information on the basis of a Head Related Transfer Function (HRTF). More particularly, when the subject of the image data moves in a direction of a user of the terminal, the portable terminal regulates strength of the first audio data to be relatively great (i.e. increasingly louder) compared to the second audio data, (or regulates strength of the second audio data to be relatively small as compared with the first audio data), and increases an amount of a low-frequency signal to be relatively increased. In addition, if the subject of the image data is separated relatively far from the direction of the user of the terminal, the portable terminal regulates the strength (volume, amplification) of the first audio data to be great, relatively subtracts the amount of the low-frequency signal, and adds a reverberation.

Further, the portable terminal applies a panning effect to the first audio data and the second audio data when output, by panning across speakers, in accordance with a motion direction of the subject of the image data.

Furthermore, if the subject moves, the portable terminal can emphasize the moving subject by decreasing a strength (volume, amplification) of the second audio data and by increasing the strength of the first audio data.

Furthermore, the portable terminal can allow the first audio data and the second audio data for the image data to be unbiased with regard to any one particular side, in order to equally apply the strength (volume, amplification) of the first audio data and second audio data.

Thereafter, the portable terminal combines the first audio data and the second audio data, and then encodes a signal-processed audio Pulse Code Modulation (PCM) signal into a compressed binary data file so that it can interwork with the image data.

Thereafter, the procedure of FIG. 3 ends.

In operation, the portable terminal described above can process the audio data to which the stereoscopic effect is applied as follows.

First, the portable terminal can generate stereoscopic data by compressing pre-acquired image data and the audio data to which the stereoscopic effect is applied into a composite signal comprised of audio data and video data, and thereafter can decode the generated stereoscopic data. Thus, the stereoscopic effect can be provided by reproducing the stereoscopic audio and the stereoscopic image.

Further, the portable terminal can provide the stereoscopic effect by generating and reproducing stereoscopic audio data (i.e., the stereoscopic effect is applied to audio data) corresponding to image data while reproducing the image data generated by using audio data to which the stereoscopic effect is not applied.

The method performed according to FIG. 3 may be provided as one or more instructions in one or more software modules stored in the storage unit that are loaded into hardware for execution. For example, the software modules may be executed by the controller 100.

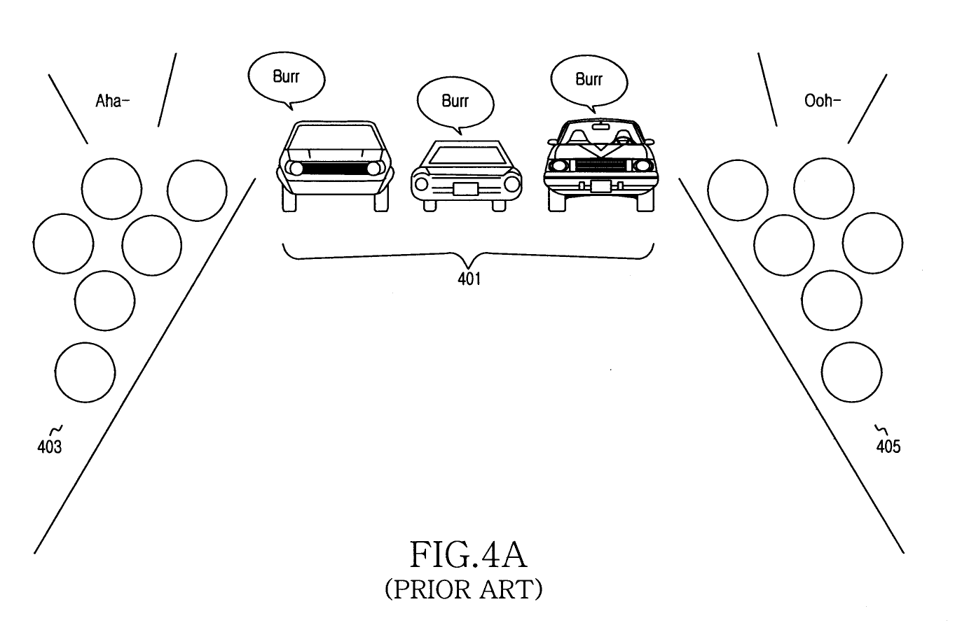

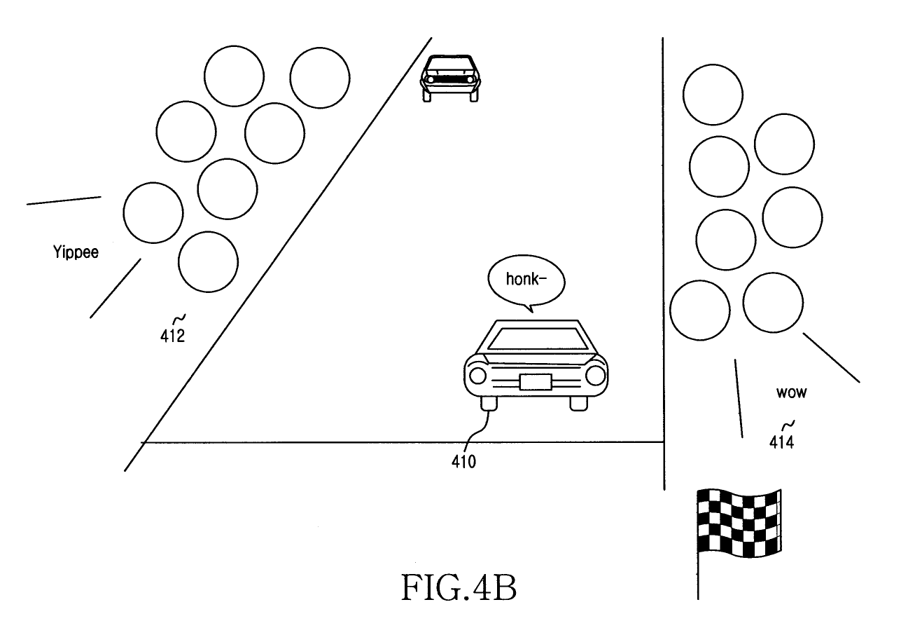

FIGS. 4A, and 4B illustrate screens for reproducing stereoscopic data of a portable terminal according to respective conventional devices and an exemplary embodiment of the present invention.

FIG. 4A illustrates a screen for reproducing stereoscopic data of a typical conventional portable terminal.

Referring now to FIG. 4A, the portable terminal can provide a stereoscopic effect by reproducing an image acquired by using a plurality of camera modules, that is, a plurality of pieces of image data acquired by capturing the same subject in different viewpoints. However, the portable terminal does not apply the stereoscopic effect to audio data. Thus, the audio data with the same effect is reproduced with respect to a subject and a background.

In other words, the portable terminal acquires image data for a racing as illustrated. Herein, a subject may be automobiles 401 for preparing for the racing, and a background may be spectators 403 and 405 located around the automobiles.

In addition, the portable terminal acquires audio data for the subject, and acquires audio data for the background. In other words, the subject generates an engine sound, and a shouting sound is generated in a left background and a right background.

The portable terminal can provide the stereoscopic effect for the image data by using the plurality of pieces of data (i.e., different pieces of image data having different viewpoints with respect to the same subject) acquired by capturing the subject. However, since the stereoscopic effect cannot be provided to the audio data, the portable terminal outputs audio data for the background and audio data for the subject with the same level, and thus a sense of reality cannot be provided.

FIG. 4B illustrates a screen for reproducing stereoscopic data of a portable terminal according to an exemplary embodiment of the present invention.

Referring now to FIG. 4B, the portable terminal can provide a stereoscopic effect by reproducing an image acquired by using a plurality of camera modules, that is, a plurality of pieces of video data acquired by capturing the same subject in different viewpoints. The typical portable terminal does not apply the stereoscopic effect to audio data and thus reproduces audio data with the same effect with respect to a subject and a background. However, the portable terminal of the present invention can apply the stereoscopic effect to audio data for the subject and background.

For example, the portable terminal extracts first audio data and second audio data from the input audio data. Herein, the first audio data implies audio data generated from the subject, and the second audio data implies audio data generated from the background.

The portable terminal can analyze location and distance information depending on a motion of the subject as ascertained from the image data, and thus can apply the stereoscopic effect to the first audio data and the second audio data.

In other words, when the subject moves, the portable terminal can decrease strength of the second audio data, and can increase strength of the first audio data corresponding to the subject. For example, as illustrated, the portable terminal can emphasize a sound of the subject by increasing a horn sound 410 of the subject which approaches a finish line and by decreasing cheering sounds 412 and 414 of spectators located nearby to be smaller than the horn sound. A Doppler effect may be considered in this process. The method performed according to FIG. 4A through 4B may be provided as one or more instructions in one or more software modules stored in the storage unit that are loaded into hardware such as a processor or microprocessor for execution. In that case, the software modules may be executed by the controller 100.

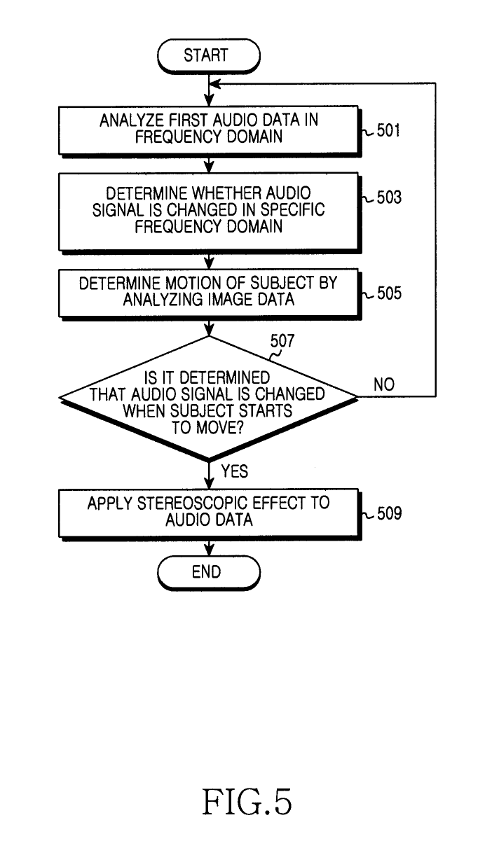

FIG. 5 is a flowchart illustrating a process of recognizing a time at which a stereoscopic effect is applied to audio data in a portable terminal according to another exemplary embodiment of the present invention.

Referring now to FIG. 5, the portable terminal analyzes first audio data in a frequency domain in step 501. Herein, the first audio data is data generated from a subject, and is audio data to which a stereoscopic effect is applied in accordance with a motion of the subject as ascertained from image data.

In step 503, the portable terminal determines whether an audio signal is changed in a specific frequency domain. In step 505, the portable terminal determines a motion of the subject by analyzing image data. In this case, the portable terminal can determine whether the audio signal is changed in the specific frequency domain by comparing an audio signal of a previous frame and an audio signal of a current frame.

In step 507, the portable terminal determines whether the audio signal is changed when the subject starts to move.

This determination at step 507 is made to recognize a motion of the subject by the use of audio data by utilizing a change of an audio signal in a frequency domain along with a motion of the subject. When the motion of the subject and the change in the audio signal simultaneously occur, it is determined that the stereoscopic effect will be applied to audio data generated along with the motion of the subject.

If it is not determined in step 507 that the audio signal is changed when the subject starts to move, returning to step 501, the portable terminal reconfirms the time at which the stereoscopic effect is applied without having to apply the stereoscopic effect to the audio data.

Otherwise, if it is determined in step 507 that the audio signal is changed when the subject starts to move, proceeding to step 509, the portable terminal applies the stereoscopic effect to the audio data. Then, the procedure of FIG. 5 ends.

In this case, if it is recognized that an audio signal of a previous frame is increased to be greater (louder audio, increased amplification) than an audio signal of a current frame, the portable terminal can recognize that the subject approaches forwards and thus can emphasize the audio data.

The reason above is to allow the portable terminal to recognize whether a main signal for image data is audio data corresponding to the subject. This is because the stereoscopic effect cannot be applied along with a motion of the subject when the main signal is a signal corresponding to a background in a case where the portable terminal applies the stereoscopic effect to the audio data by using only the motion of the subject of the image data.

Taking a boxing match for example, the portable terminal generally recognizes a motion of an athlete as a subject and then applies the stereoscopic effect to audio data generated from image data of the boxer.

The reason is because, if the portable terminal defines the audio data generated from the boxer as a background signal and defines audio data generated from an audience as a main signal, a cheering sound of the audience can be emphasized along with the motion of the athlete which is the subject.

The method performed according to FIG. 5 may be provided as one or more instructions in one or more software modules stored in the storage unit that are loaded into hardware such as a processor or microprocessor for execution. The software modules may be executed by the controller 100.

Methods based on the exemplary embodiments disclosed in the claims and/or specification of the present invention can be implemented strictly in hardware, software that is loaded into hardware for execution, or a combination of both.

When implemented in software that is loaded into hardware for execution, a computer readable recording medium for storing one or more programs (i.e., software modules) can be provided. The one or more programs stored in the computer readable recording medium are configured for execution performed by hardware, as one or more processors or microprocessors in an electronic device such as a portable terminal. The one or more programs include instructions that when loaded into hardware that allow the electronic device to execute the methods based on the exemplary embodiments disclosed in the claims and/or specification of the present invention.

The program (i.e., the software module or software) that is loaded into hardware for execution such as a processor or microprocessor can be stored in a random access memory, a non-volatile memory including a random access memory, a Read Only Memory (ROM), an Electrically Erasable Programmable Read Only Memory (EEPROM), a magnetic disc storage device, a Compact Disc-ROM (CD-ROM), Digital Versatile Discs (DVDs) or other forms of optical storage devices, and a magnetic cassette. Alternatively, the program can be stored in a memory configured in combination of all or some of these storage media. In addition, the configured memory may be plural in number.

Further, the program can be remotely stored in an attachable storage device capable of accessing the electronic device through a communication network such as the Internet, an Intranet, a Local Area Network (LAN), a Wide LAN (WLAN), a Storage Area Network (SAN), or a communication network configured by combining the networks. The storage device can access the electronic device through an external port. The claimed invention is not directed to a carrier wave and when the instructions are remotely stored, they are downloaded and loaded into hardware for execution such as a processor or microprocessor.

For example, a module of an electronic device including hardware such as one or more processors or microprocessors, a memory, and one or more modules stored in the memory and configured to be executed by the hardware comprising one or more processors can include an instruction for acquiring image data and audio data to generate stereoscopic data, recognizing motion information of a subject from the stereoscopic data, applying a stereoscopic effect to the image data, and applying the stereoscopic effect to the audio data in accordance with the motion information of the subject.

In addition, the module of the electronic device can include an instruction that is executed by hardware such as a processor or microprocessor and functions to divide the acquired image data into a subject corresponding to a focal point and a background and for recognizing location and distance information of the subject.

In addition, the module of the electronic device can include an instruction that when loaded into hardware for execution into a processor or microprocessor, separate the acquired audio data into first audio data which is audio data generated from the subject of the image data, for separating second audio data which is audio data generated from the background of the video data, and for applying the stereoscopic effect to the first audio data and the second audio data by using the motion information of the subject.

In addition, the present invention can reproduce stereoscopic data by generating the stereoscopic data by the use of image data and audio data to which the stereoscopic effect is applied or, when reproducing stereoscopic data to which the stereoscopic effect is not applied to audio data, reproducing the stereoscopic data by applying the stereoscopic effect to the audio data by confirming subject information of the image data.

In addition, in a case where first audio data is generated from image data of the subject, the present invention can apply the stereoscopic effect to the audio data.

In addition, the present invention may determine that the first audio data is generated from the subject of the image data if it is determined that the audio signal is changed when the subject starts to move in a case where the first audio data is analyzed in a frequency domain and then whether an audio signal is changed is determined when the subject starts to move.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitutes hardware in the claimed invention.

As described above, the present invention is for applying a stereoscopic effect to audio data when reproducing stereoscopic data. By applying the stereoscopic effect not only to the image data but also to the audio data by ascertaining motion of a subject based on the video data, the stereoscopic effect with a greater sense of reality can be provided to a user.

While the present invention has been particularly shown and described with reference to exemplary embodiments thereof, it will be understood by those skilled in the art that various changes in form and details may be made therein without departing from the spirit and scope of the present invention as defined by the appended claims

What is claimed is:

1. An apparatus for generating stereoscopic data in a portable terminal, the apparatus comprising:
an image processor that applies a stereoscopic effect to image data by acquiring the image data for generating the stereoscopic data, identifies a subject from the image data and recognizes subject motion information of the image data; and
an audio processor that applies to acquired audio data a stereoscopic effect to the audio data that corresponds with the subject identified in the image data in accordance with the recognized subject motion information of the image data.

2. The apparatus of claim 1, wherein the image processor comprises:
a subject checker that separates the acquired image data into the subject corresponding to a focal point and a background;
a location information analyzer that confirms a location information of the subject separated by the subject checker; and
a distance information analyzer that confirms distance information of the subject separated by the subject checker by recognizing a subject location of previous image data and compares with a subject location of the acquired image data, and thereafter confirms distance information based on a subject motion of the subject.

3. The apparatus of claim 1, wherein the audio processor comprises:
a signal extractor that separates from the acquired audio data a first audio data generated from the subject and a second audio data generated from the background; and
an effect applying unit that applies the stereoscopic effect to the first audio data and the second audio data by using the subject motion information of image data recognized by the image processor.

4. The apparatus of claim 3, wherein the effect applying unit configures the first audio data or the second audio data in accordance with the subject motion information.

5. The apparatus of claim 3, further comprising a microphone array which record sounds from the subject and the background at different angles utilizing a beamforming technique.

6. The apparatus of claim 1, wherein the apparatus for generating the stereoscopic data is arranged within portable terminal and generates and reproduces the stereoscopic data by using the image data and audio data to which the stereoscopic effect is applied, and
wherein when reproducing image data in which the stereoscopic effect is not applied to the audio data, the portable terminal confirms subject motion information of the image data and reproduces the image data by applying the stereoscopic effect to the image data.

7. The apparatus of claim 1, wherein the audio processor applies the stereoscopic effect to the acquired audio data when the first audio data is generated from a subject of the image data.

8. The apparatus of claim 7, wherein the audio processor analyzes the first audio data in a frequency domain, and when the audio processor determines that an audio signal is changed when the subject starts to move, the audio processor determines that the first audio data is generated from the subject of the image data.

9. A method of generating stereoscopic data in a portable terminal, the method comprising:
acquiring image data and audio data for generating the stereoscopic data;
recognizing subject motion information of a subject from the acquired image data by recognizing a subject location of previous image data and comparing with a subject location of the acquired image data;
applying the stereoscopic effect to the image data; and
applying the stereoscopic effect to the audio data in accordance with the subject motion information recognized in the image data.

10. The method of claim 9, wherein the recognizing of the subject motion information from the stereoscopic data comprises:
separating the acquired image data by a subject checker into a subject corresponding to a focal point and a background; and
recognizing by a location information analyze and a distance information analyzer respective location and distance information of the subject.

11. The method of claim 9, wherein the applying of the stereoscopic effect to the audio data comprises:
separating first audio data by a main signal audio extractor the first audio data generated from the subject of the image data from the acquired audio data;
separating second audio data by a background audio signal extractor the second audio data generated from the background of the image data from the acquired audio data; and
applying the stereoscopic effect to the first audio data and the second audio data by using the subject motion information of the image data.

12. The method of claim 11, wherein the applying of the stereoscopic effect to the first audio data and the second audio data comprises configuring the first audio data or the second audio data utilizing a beamforming technique of a microphone array in accordance with the subject motion information of the image data.

13. The method of claim 9,wherein the method for generating the stereoscopic data in the portable terminal comprises generating and reproducing the stereoscopic data by using the image data and audio data to which the stereoscopic effect is applied, and
wherein when reproducing image data in which the stereoscopic effect is not applied to the audio data, the portable terminal confirms subject motion information of the image data and reproduces the image data by applying the stereoscopic effect to the image data.

14. The method of claim 9, wherein the applying of the stereoscopic effect to the audio data in accordance with the subject motion information comprises applying the stereoscopic effect to the first audio data.

15. The method of claim 14, wherein the applying of the stereoscopic effect to the audio data in accordance with the subject motion information comprises:
analyzing the first audio data in a frequency domain, and thereafter determining whether an audio signal has changed when the subject moves; and
after determining that the audio signal has changed when the subject moves, determining that the first audio data is generated by the subject of the image data.

16. An electronic device comprising:
one or more controller processors;
a non-transitory memory; and
one or more modules stored in the memory and configured for execution when loaded into the one or more controller processors,
wherein the one or more modules acquire image data and audio data for generating the stereoscopic data, recognize subject motion information from the image data, apply the stereoscopic effect to the image data, and apply the stereoscopic effect to the audio data in accordance with the subject motion information.

17. The electronic device of claim 16, wherein the one or more modules when executed in the one or more controller processors divide the acquired image data into a subject corresponding to a focal point and a background, and recognize location and distance information of the subject.

18. The electronic device of claim 16, wherein the one or more modules when executed in the one or more controller processors separate first audio data which is audio data generated by the subject of the image data from the acquired audio data, separates second audio data which is audio data generated by the background of the image data from the acquired audio data, and applies the stereoscopic effect to the first audio data and the second audio data by using the subject motion information of the image data.

19. The electronic device of claim 16, wherein the one or more modules when executed in the one or more controller processors generate and reproduces the stereoscopic data by using the image data and audio data to which the stereoscopic effect is applied, or confirm subject motion information of the image data and reproduces the image data by applying the stereoscopic effect to the audio data.

20. The electronic device of claim 16, wherein the one or more modules when executed in the one or more controller processors apply the stereoscopic effect to the audio data when the first audio data is generated from a subject of the image data.

21. The electronic device of claim 20, wherein the one or more modules when executed in the one or more controller processors analyze the first audio data in a frequency domain, and thereafter determining whether an audio signal is changed when the subject moves, and after determining that the audio signal is changed when the subject start moves, determines that the first audio data is generated from the subject of the image data.
